(19) United States
(12) Patent Application Publication
(10) Pub. No.: US 2008/0176154 A1
(43) Pub. Date: Jul. 24, 2008

(54) ELECTRO-PHOTOGRAPHIC PHOTORECEPTOR, PRODUCTION METHOD THEREOF, AND ELECTRO-PHOTOGRAPHIC APPARATUS USING ELECTRO-PHOTOGRAPHIC PHOTORECEPTOR

(75) Inventor: Akira GYOUTOKU, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/953,336

(22) Filed: Dec. 10, 2007

(30) Foreign Application Priority Data
Dec. 11, 2006 (JP) 2006-333006
Jan. 25, 2007 (JP) 2007-014775

(51) Int. Cl. G03G 15/00; G03G 5/00

(52) U.S. Cl. 430/58.1; 430/58.05; 430/59.1; 430/127

(57) ABSTRACT

In the aim of providing a photoreceptor which is highly sensitive, highly abrasion-resistant, and reduced in cost, a production method for the photoreceptor, and an electrophotographic apparatus using the photoreceptor, the photoreceptor has a structure wherein an organic film (or an amorphous silicon film) used as a charge generation layer 2 and formed on an electroconductive support 1 and an inorganic metal oxide having optical transparency and used as a charge transport layer 3 are stacked. Further, a buffer layer 4 is formed between the charge generation layer 2 and the charge transport layer 3 when so required. Also, the metal oxide used as the charge transport layer 3 and having optical transparency is formed by employing an aerosol deposition method.

### BACKGROUND

1. Field of the Invention

This invention relates to a function separation type electro-photographic photoreceptor wherein a charge generation layer and a charge transport layer are stacked on an electro-conductive support and, more specifically, to the electro-photographic photoreceptor wherein a metal oxide having optical transparency is used as the charge transport layer, a production method thereof, and an electro-photographic apparatus using the electro-photographic photoreceptor.

2. Description of the Related Art

In electro-photography, a photoconductive material for forming a photosensitive layer in a photoreceptor is required to have characteristics such as high sensitivity, a high SN ratio, an absorption spectrum suitable for spectrum characteristics of an electromagnetic wave to be irradiated, rapid photo response, a desired dark resistance value, harmlessness to human body in use and disposal.

In order to satisfy these properties and characteristics, various material and structures have heretofore been proposed, and two photoreceptors, namely an organic photoreceptor having an organic photoconductive substance as a main ingredient and an inorganic photoreceptor using an amorphous silicon-based material as a photoelectric material, are currently mainstream photoreceptors. As a brief explanation of characteristics of the two types of photoreceptors, the organic photoreceptor is highly productive and enables cost reduction, but durability thereof is not sufficient. The amorphous silicon photoreceptor has a remarkably high durability, but a cost thereof is increased due to necessity of expensive vacuum device and a complicated film formation technology. Therefore, usages of the photoreceptors are classified depending on prices and functions, and the organic photoreceptors are mainly used for intermediate and low speed devices, while the amorphous silicon is used for high-speed devices.

The organic photoreceptor has many advantages such as easy development of materials in accordance with various exposure light sources from visible light to infrared light, enabling to select a material free from environment pollution, a low production cost, and the like. As drawbacks of the organic photoreceptor, there are problems that scratches are easily caused on a surface due to weak mechanical strength, image quality is degraded along with deterioration in electrostatic characteristics of the photoreceptor due to weak chemical resistance when printing a large number of copies, and the like. Therefore, for the organic photoreceptor, there is a constant demand for improvement in durability (abrasion resistance) against contamination and scratches on the surface that are caused by a mechanical external force applied when transferring a toner image formed on the photoreceptor onto a paper or the like, cleaning a residual toner on the photoreceptor, and the like.

As one example of improvement measures, there has been known a technology of adding fluorine-containing resin fine particles of a polytetrafluoroethylene resin (PTFE) or the like to an outermost layer of the photoreceptor for the purpose of improving contamination and abrasion resistance of the photoreceptor. Particularly, as a means for improving the abrasion resistance by effectively reducing an abrasion coefficient of a surface of the photoreceptor, Patent Publication 1, for example, discloses a technology of using fluorine-containing resin fine particles having a small crystallization degree and a small diameter.

As another method, a method of forming a protection layer of high rigidity on an outermost surface of the photosensitive layer has been known. One preferred example thereof is carbon or a diamond-like carbon film (DLC film) formed by using carbon. As disclosed in Patent Publication 2, the DLC film has an amorphous structure wherein a diamond bonding and a graphite bonding are comprised, for example, and is manufactured by using a vacuum film formation method such as plasma CVD, optical CVD, sputtering, and the like.

Generally, in the inorganic photoreceptors using amorphous silicon, an electro-conductive support is heated to 50° C. to 400° C., and a photoconductive layer made from an amorphous silicon-based material is formed on the support by a film formation method such as vacuum vapor deposition, sputtering, ion plating, heat CVD, optical CVD, and plasma CVD. Among the methods, plasma CVD disclosed in Patent Publication 3 and the like, i.e. a method of decomposing a raw material gas by glow discharge and forming an amorphous silicon-based deposited film on a substrate, has been in practical use as the most suitable method.

However, since the raw material gas used in plasma CVD is a toxic gas such as silane and diborane, it is necessary to use an exhaust gas treatment system for detoxifying the gases, thereby increasing an equipment cost for the system. Also, since a film formation rate of amorphous silicon achieved by plasma CVD is not more than a several micrometers per hour, it is necessary to consume considerable time for forming 10 to 20 μm that is ordinarily required in photoreceptors, thereby increasing a processing cost. As a processing improvement measure, productivity is enhanced by largely improving film formation rates of amorphous silicon and SiC used for the protection layer by directly applying a DC bias potential to a photosensitive drum as disclosed in Non-Patent Publication 1, for example.

As the inorganic photoelectric materials other than the amorphous silicon described above, an oxide semiconductor may be listed as a candidate, and one of popular examples thereof may be zinc oxide. Though a photoreceptor using zinc oxide is hardly seen nowadays, it has been widely used as a low cost and harmless electro-photographic photoconductor such as an electro-photographic photoreceptor for plain paper and an electro-facsimile paper due to its structure wherein zinc oxide is dispersed in to a resin bonding agent (see Patent Publication 4, for example). However, since the electro-photographic photoreceptor with the dispersion system essentially is a two-dimensional system substance formed of zinc oxide and a resin, there are drawbacks that the photoreceptor is deteriorated extremely rapidly during processing and is influenced by environmental atmosphere. Since zinc oxide has its photosensitivity in the short wavelength range centered on a wavelength of 380 nm, a factor of the poor reliability of the photoreceptor obtained by dispersing zinc oxide is the necessity of imparting spectral sensitivity in the long wavelength range to zinc oxide by achieving physical sensitization, chemical sensitization, pigment sensitization, or the like through the dispersion into resin. However, as disclosed in Patent Publication 5, for example, attempts have recently been made for application as a thin film type photoreceptor that compensates for the reliability drawbacks by forming a thin film from zinc oxide alone without dispersing zinc oxide. Also, as an attempt for improving productivity of the photoreceptor using amorphous silicon, there has been proposed a structure wherein zinc oxide serving as a charge transport layer and amorphous silicon serving as a charge generation layer are formed in this order on an electro-conductive support as disclosed in Patent Publication 6, for example.

Patent Publication 1: JP-A-08-328287

Patent Publication 2: JP-A-07-239565

Patent Publication 3: JP-A-06-273956

Patent Publication 4: JP-A-01-031160

Patent Publication 5: JP-A-2000-321803

Patent Publication 6: JP-A-59-136741

Non-Patent Publication 1: B-12 of collection of papers of Image Conference Japan 2006

As described in the foregoing, though both of the organic photoreceptor and the inorganic photoreceptor have been in practical use, various attempts have continuously been made for the purpose of achieving further improvements. The problem of organic photoreceptors is the durability, and life deciding factors are attributable to material deterioration and mechanical deterioration due to film abrasion.

In turns major problems of amorphous silicon photoreceptors are the complicated processing for accurately controlling a doping concentration, the slow film formation speed, and the high cost due to necessity of large scale equipment.

Though the abrasion resistance is improved by the technology disclosed in Patent Publication 1 as compared to conventional organic materials, there is a limit for the substantive improvement of material. Though the durability is improved by fluorine, the material obtained by the technology is easily influenced by external factors such as ozone, oxygen, and moisture as compared to inorganic materials and, therefore, cannot be considered as a permanent improvement.

The method of protecting the organic film with the use of the inorganic protection film disclosed in Patent Publication 2 improves the abrasion property and has an effect of preventing entrance of external factors such as ozone, oxygen, and moisture. It is necessary to increase a film thickness of the protection film for the effect to be fully exhibited. However, from the view point of maintaining image quality such as prevention of blurring of a latent image formed on the photoreceptor and the like, it is impossible to increase the film thickness of the protection film, thereby failing to fully elicit the performance of the protection film. Due to such performance trade-off, the durability becomes insufficient, too.

Though the spectral sensitivity of zinc oxide is improved to the long wavelength range with the method of forming zinc oxide by plasma spraying disclosed in Patent Publication 5, the spectral sensitivity is about 430 nm which is insufficient for being photosensitized with a red laser beam of about 780 nm ordinarily used in electro-photographic apparatuses and has difficulty in obtaining good image quality. Also, even when a transparent oxide other then zinc oxide is formed by the plasma spraying method, it is difficult to expect a large improvement in spectral sensitivity as well as to improve the basic characteristic of having the absorption only in the short wavelength range.

Since amorphous silicon is formed on zinc oxide in the method of stacking amorphous silicon and zinc oxide disclosed in Patent Publication 6, a surface of zinc oxide is damaged by exposure to plasma containing toxic gas that is required for forming amorphous silicon, thereby making it difficult to achieve good characteristics. Also, since it is possible to perform valence control of amorphous silicon by doping with impurities, it is possible to obtain a P-type semiconductor by using a diborane gas as well as to obtain an N-type semiconductor by adding phosphine; however, zinc oxide is mainly used as the N-type semiconductor unlike the amorphous silicon. Therefore, since only a negatively charged photoreceptor is obtainable by using the conventional structure where the zinc oxide structure and amorphous silicon are formed on the electro-conductive support, it is impossible to realize a positively charged photoreceptor that is capable of suppressing generation of ozone and has higher durability as compared to the negatively charged photoreceptor.

With the method of forming a film by employing CVD using DC plasma disclosed in Non-Patent Publication 1, since the amorphous silicon film formation rate as improved is 1 to 2 μm/hr, a remarkably long processing time about 10 hours is required when a film thickness of 20 μm is required. Also, since it is necessary to accurately control a doping concentration that is required for obtaining predetermined characteristics with this method, the complication of processing is not improved.

As described in the foregoing it has been difficult to obtain an electro-photographic photoreceptor that is highly sensitive, excellent in durability, and reduced in cost with the conventional methods.

### SUMMARY

This invention has been accomplished in view of the above described problems, and an object thereof is to provide an electro-photographic photoreceptor which is highly sensitive, excellent in mechanical strength, and reduced coast, a production method therefor, and an electro-photographic apparatus using the electro-photographic photoreceptor and capable of achieving high image quality.

In order to solve the above problems and to attain the object, a photoreceptor of this invention comprises a support of which at least a surface layer has electro-conductivity, a charge transport layer formed from a metal oxide having optical transparency, and a charge generation layer formed between the support and the charge transport layer.

According to this invention, it is possible to separate a function of generating a charge upon reception of light from a function of transporting the charge since the metal oxide functioning as the charge transport layer and having optical transparency is formed on the charge generation layer.

Since a wavelength of the light to be irradiated must be a short wavelength for imparting a function of generating charge by photoelectric effect to the metal oxide having optical transparency, i.e. to a semiconductor having a wide band gap, the inexpensive infrared lasers cannot be used; however, the structure of this invention eliminates such limitation. Also, since the charge transport layer of the electro-photographic photoreceptor according to this invention has the optical transparency, it is possible to eliminate a loss for a time during which the light travels from a light source to the charge generation layer as well as to maintain high sensitivity. Further, since the outermost surface is covered with the metal oxide film, not with an organic substance, which is an inorganic substance having higher reliably than organic substances, it is possible to achieve high durability (abrasion resistance) as well.

### BRIEF DESCRIPTION OF THE DRAWINGS

FIG. 1 is a diagram showing a layer structure of an electro-photographic photoreceptor according to Embodiment 1 of this invention.

FIG. 2 is a diagram showing a layer structure of a photoreceptor according to Embodiment 2 of this invention.

FIG. 3 is a schematic diagram showing a film formation apparatus using an aerosol deposition method according to Embodiment 3 of this invention.

FIG. 4 is a schematic block diagram showing an electro-photographic apparatus according to Embodiment 4 of this invention.

FIG. 5 is a perspective view showing another example of exposure device applied to the electro-photographic apparatus according to Embodiment 4 of this invention.

FIG. 6 is a diagram showing a layer structure of a stacked electro-photographic photoreceptor according to Embodiment 5 of this invention.

FIG. 7 is a diagram showing characteristics indicating results of measurement of spectral absorption characteristics of zinc oxide in Embodiment 5 of this invention.

FIG. 8 is a diagram showing characteristics indicating results of measurement of a state of electron energy by an X-ray electron spectroscopy in Embodiment 5 of this invention.

FIG. 9 is a diagram showing characteristics indicating results of observation of crystal structures by x-ray diffraction of a zinc oxide film containing nitrogen and a zinc oxide film not containing nitrogen.

FIG. 10 is a diagram showing a structure of a single layer electro-photographic photoreceptor according to Embodiment 6 of this invention.

FIG. 11 is a schematic diagram showing a film formation apparatus using an aerosol deposition method according to Embodiment 7 of this invention.

FIG. 12 is a schematic block diagram showing an electro-photographic apparatus according to Embodiment 8 of this invention.

FIG. 13 is a perspective view showing another example of exposure device applied to the electro-photographic apparatus according to Embodiment 8 of this invention.

### DETAILED DESCRIPTION

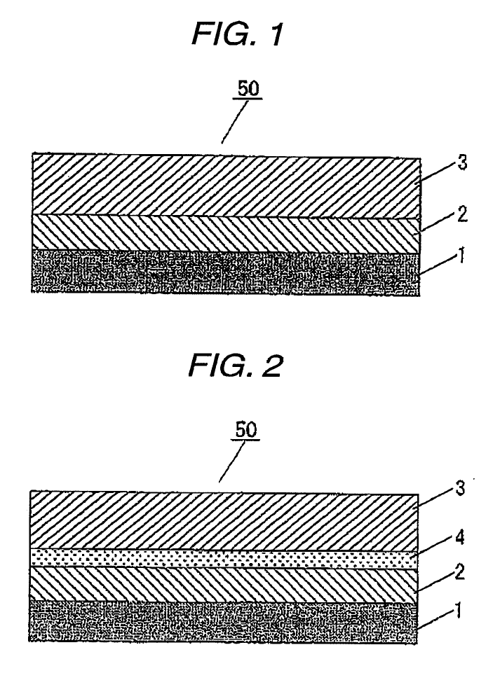

Hereinafter, embodiments of this invention will be described by using FIGS. 1 to 13.

### Embodiment 1

Hereinafter, this invention will be described in detail.

FIG. 1 is a schematic diagram showing a layer structure of an electro-photographic photoreceptor (hereinafter referred to as photoreceptor) 50 according to Embodiment 1 of this invention.

The photoreceptor 50 is ordinarily formed into a drum-like shape, for example, and shown in FIG. 1 is an enlarged view of a section of a main part.

Referring to FIG. 1, an electro-conductive support is denoted by 1, a charge generation layer formed of an organic film, for example, is denoted by 2, and a charge transport layer formed of a metal oxide film having optical transparency is denoted by 3, the charge generation layer 2 and the charge transport layer 3 are formed in this order on the support.

In order that the support 1 itself has electro-conductivity, aluminum may typically be used for the support 1. Other than the aluminum, an aluminum alloy, copper, a stainless steel, chromium, titanium, nickel, magnesium, indium, gold, platinum, silver, iron, and the like may be used for the support 1. In addition to the above, those having electro-conductivity and obtained by forming a film of aluminum, indium oxide, tin oxide, gold, or the like by vapor deposition on a dielectric substrate such as plastic, those obtained by mixing plastic or a paper with electro-conductive fine particles, and the like may be used. The electro-conductive support 1 is required to have uniform electro-conductivity, and a smooth surface property is important. Since the smoothness of a surface of the support 1 greatly influences on uniformity of the charge generation layer 2 and the charge transport layer 3 that are formed thereon, a surface roughness thereof may preferably be 0.5 μm or less.

That is, the above-described structure is neither more nor less than a structure having the support 1 of which at least the surface has electro-conductivity, the charge transport layer 3 formed of the optically transparent metal oxide, and the charge generation layer 2 disposed between the support 1 and the charge transport layer 3.

Though the structure of forming the charge generation layer 2 directly on the support 1 is shown in FIG. 1, an underlayer (not shown) having an injection prevention function and an adhesion function may be provided between the support 1 and the charge generation layer 2. The underlayer is used for electrically setting a resistance between the support 1 and the charge generation layer 2 within a predetermined range and is indispensable when the charge generation layer 2 is formed of amorphous silicon. Typical examples of materials for the underlayer include casein, polyvinylalcohol, nitrocellulose, an ethylene-acrylic acid copolymer, polyvinylbutyral, a phenol resin, polyamide, polyurethane, gelatin, and the like.

The charge generation layer 2 may not necessarily be specified, and any of known charge generation layers may be used. Examples of the charge generation layers include metal phthalocyanines such as titanyl phthalocyanine, non-metallic phthalocyanine, and copper phthalocyanine; naphthalocyanines; a mixed crystal thereof; an azo compound; selenium-tellurium; a pyrylium compound; a perylene-based compound; a cyaninebased compound; a squarium compound; a polycyclic quinone compound; and the like.

Layer formation is performed by using these charge generation substances alone or dispersing the charge generation substance into an appropriate binder resin. As the binder resin, selection may be made from a wide range of insulating resins, and examples thereof include polyvinylbutyral, polyvinylalcohol, polyarylate, polyamide, an acryl resin, polyvinyl acetate, a phenol resin, an epoxy resin, polyester, polycarbonate, polyurethane, a cellulose-based resin, and the like. The resin may suitably be contained in the charge generation layer 2 in an amount of 80 parts by weight or less, preferably 50 parts by weight or less. A thickness of the charge generation layer 2 may ordinarily be about several micrometers, particularly preferably 0.05 to 2 μm. The above-described charge generation substance is dispersed by means of a homogenizer, ultrasonic, a ball mill, a vibratory ball mill, a sand mill, an attritor, a roll mill, and the like together with the above-described binder resin and a solvent to form a film by coating and drying. A sublimation type material such as the phthalocyanine-based material is used alone for forming a film by vacuum vapor deposition.

The metal oxide having optical transparency is used for the charge transport layer 3. Metal oxide materials are stable in the atmosphere and abundant as a resource, and many of them are pollution free. Also, since the metal oxide materials enable to employ a wide range of film formation methods such as sputtering, plasma CVD, and the like requiring a vacuum device, dip coating employing a sol-gel method, and spin coating, the use of the metal oxide material as a main material of the optical functional film offers many advantages.

Since the optically transparent metal oxide used in Embodiment 1 is used as the charge transport layer 3 of the photoreceptor 50, any material having functions of not absorbing light in a wavelength band of exposure light, allowing the exposure light to reach the charge generation layer 2, and transporting generated charges may be used. However, since metal oxide materials such as lead oxide (PbO), cadmium oxide (CdO), and the like has drawbacks in stability and non-polluting property, it is difficult to enjoy the advantages of the above metal oxides as well as to achieve practical application with the use of such metal oxides. Since zinc oxide (ZnO), titanium oxide (TiO₂), and tin oxide (SnO₂) have large band gaps of 3.3 eV, 3.2 eV, and 3.6 eV and are stable materials, the use of such metal oxides for the charge transport layer 3 for the photoreceptor 50 offer remarkably great advantages.

It is considered that the higher the transmittance the better the transparency of the metal oxide used as the charge transport layer 3 in Embodiment 1, but this is not the unique factor for deciding the transparency. When the charge generation layer 2 and the charge transport layer 3 are excellent in electric characteristics and highly sensitive, a small loss in exposure energy caused by the charge transport layer 3 does not cause any trouble in the characteristics of the photoreceptor 50 in many cases.

Those having a transmittance of transmitting 60% or more of the exposure energy fully exhibit the function as the metal oxide to be used for the structure of Embodiment 1.

A method of forming a highly rigid protection layer on an outermost surface of a photosensitive layer has heretofore been known, and such method may of course be applied to this invention. Preferred examples of the method is the case of using carbon or a thin film formed by mainly using carbon, particularly diamond or a diamond-shaped carbon film (DLC), as a protection film. The DLC film is an amorphous structural body in which a diamond bonding and a graphite bonding are mixed and obtainable by employing a vacuum film formation method such as plasma CVD, optical CVD, and sputtering and supplying a hydrogen, fluorine (NF₃), nitrogen (N₂), or boron (BF₃) gas when so required. In the case of forming the DLC film as the protection film (not shown) on the charge transport layer 3, it is necessary to consider damages to be caused on the metal oxide film used as the charge transport layer 3 as well as to set optimal conditions considering film formation conditions such as a film formation rate, substrate heating, and a bias voltage and a gas to be used. A required film thickness of the protection film is not particularly specified, but a film thickness of 1 μm or less is generally preferred since sensitivity as the photoreceptor 50 is degraded when the thickness is too high resulting in failure to obtain good image quality.

Though the example of using the organic material as the charge generation layer 2 is described in Embodiment 1, an amorphous silicon film may be used as the charge generation layer 2. In this case, the electro-conductive support 1 is heated to 200° C. to 300° C., and the amorphous silicon film is formed on the support 1 by a film formation method such as vacuum vapor deposition, sputtering, ion plating, thermal CVD, optical CVD, and plasma CVD. In this film formation, it is particularly preferable to form the amorphous silicon film on the support 1 by the plasma CVD.

Also, it is preferable to perform a heat treatment after stacking the charge generation layer 2 formed of the organic/amorphous silicon film, the charge transport layer 3 formed of the optically transparent metal oxide film, and a buffer layer and/or the protection layer when so required (the outermost surface of the photoreceptor 50 is the protection layer (not shown) or the charge transport layer 3 in the case where the protection layer is not provided). By the heat treatment, diffusion occurs at the boundaries between the adjacent layers to increase adhesion between the layers, so that peeling due to external forces is prevented. Since a heat treatment temperature is not particularly defined and can be varied depending on combination of the materials, the heat treatment temperature may be optimized in view of deterioration in characteristics and improvement in adhesion.

### Embodiment 2

FIG. 2 is a diagram showing a layer structure of a photoreceptor 50 according to Embodiment 2 of this invention.

Embodiment 2 shows a section structure of the photoreceptor 50 provided with a buffer layer 4 between the charge generation layer 2 and the charge transport layer 3.

The difference between Embodiment 2 and Embodiment 1 is the provision of the buffer layer 4 between the charge generation layer 2 and the charge transport layer 3. The role of the buffer layer 4 in Embodiment 2 is to reduce damage to be caused on the charge generation layer 2 by the formation of metal oxide as the charge transport layer 3 on the organic layer serving as the charge generation layer 2.

The metal oxide is formed by plasma CVD, sputtering, dip coating, or spin coating, and an ultraviolet ray as described above, but secondary electrons existing in plasma can damage on the organic film to considerably degrading the ability of generating charges. Also, in dip coating and spin coating using a solvent in which a metal oxide is dispersed, a uniform and desired thickness cannot be achieved in some cases since the organic film itself of the charge generation layer 2 is dissolved by the solvent. Particularly, in the case where the organic film serving as the charge generation layer 2 exists as a single matter such as the phthalocyanine-based film, it is impossible to form the charge transport layer 3 by the method using solvent. In turn, in the case of using the charge generation layer 2 wherein the organic material is dispersed into the binder, though it is possible to form the charge transport layer 3 by using a solvent by selecting those in which the charge transport layer 3 is dispersed as the solvent, the selection of the material for the solvent is important, and the conditions are considerably limited.

The above problems are solved by forming the charge transport layer 3 after forming the buffer layer 4 on the charge generation layer 2, thereby enabling to provide the photoreceptor 50 having good characteristics.

Characteristics required for the buffer layer 4 are a function of protecting the charge generation layer 2 by diminishing damages to be caused on the charge generation layer 2 when forming the charge transport layer 3 and a function of delivering charges between the charge generation layer 2 and the charge transport layer 3 in order to satisfy the characteristics as the photoreceptor 50. Since the buffer layer 4 may preferably exhibit conductivity or semi-conductivity, graphite, fullerene, and the like may preferably be used therefor, for example, and an insulator may be used depending on the case. For example, in the case of using an insulator of about several nanometers to 30 nm as the buffer layer 4, such film thickness range fails to cover the whole surface of the organic layer as a perfect film but exists in the form of an island. Also, since the surface of the charge generation layer has unevenness of several to several tens of nanometers, the region is in a state where the organic layer serving as the charge generation layer 2 and the insulating film serving as the buffer layer 4 are mixed, and the buffer layer functions as the conductor or semiconductor even when the buffer layer 4 is the insulator, thereby making it possible to deliver charges.

It is preferable that the buffer layer 4 has the optical transparency, too, but it is possible to use a non-transparent conductor such as a metal as the buffer layer 4. Though the metal loses optical transparency when a film thickness thereof is increased, a small film thickness of about several tens of nanometers allows light to pass therethrough. Of course, transmittance is degraded with the increase in film thickness and varied depending on a material of the metal. For example, in the case of aluminum, a film thickness of 10 nm achieves a visible light transmittance of about 30%, and a film thickness of 50 nm achieves a visible light transmittance of about 50%. Also, in the case of MgAg, a film thickness of 10 nm achieves a visible light transmittance of about 50%, and a film thickness of 5 nm achieves a visible light transmittance of about 70%. As described above, the metal film which is not transparent can be used as the buffer layer 4 by selecting the material and the film thickness.

A film formation method for forming the buffer layer 4 is not particularly specified, but it is meaningless if the formation method causes damages on the charge generation layer 2 serving as a base for forming the buffer layer 4. Therefore, vacuum vapor deposition that hardly or never causes damages on the base is preferred, and sputtering with which plasma is generated is capable of forming the buffer layer 4 without damaging on the base layer by employing a means that reduces influences of the plasma to the substrate as much as possible such as an opposed target type sputtering apparatus. Further, an electro-conductive polymer may be used as the buffer layer 4, and, particularly, a π-conjugate electro-conductive polymer may preferably be used. In this case, by using a material dispersed into the binder for the charge generation layer 2, it is possible to form the buffer layer 4 of the electro-conductive polymer on the charge generation layer 2 as well as to cause the function of the buffer layer 4 to be exhibited, thereby realizing the effects of this invention.

### Embodiment 3

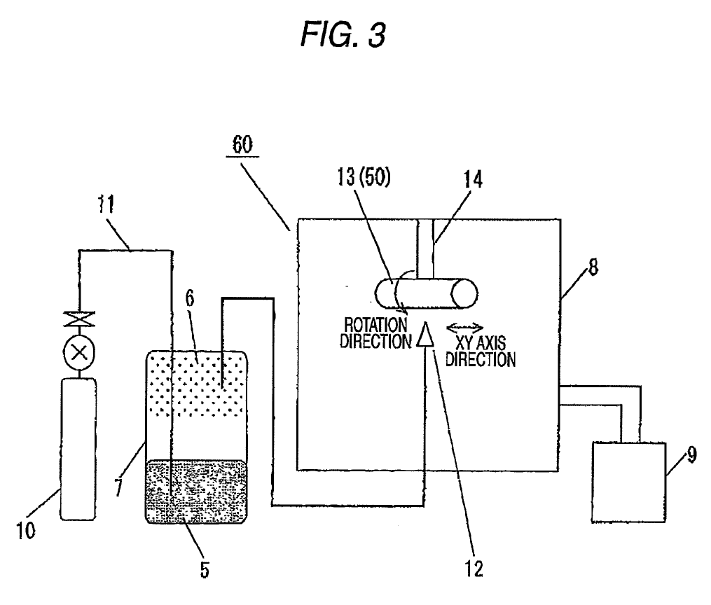

FIG. 3 is a schematic diagram showing a film formation apparatus 60 using an aerosol deposition method according to Embodiment 3 of this invention.

Hereinafter, a production method of an electro-photographic photoreceptor using the aerosol deposition method which is suitable as a method for forming a metal oxide having optical transparency will be explained using FIG. 3.

The film formation apparatus 60 used in Embodiment 3 is provided with an aerosol generator 7 for forming an aerosol 6 by dispersing material particles 5 into a carrier gas, a film formation chamber 8 for depositing the aerosol 6 by spraying the aerosol 6 from a nozzle, and the like, and an evacuation pump 9 is connected to the film formation chamber 8.

To the aerosol generator 7, a gas bomb 10 for introducing the carrier gas is connected via an introduction piping 11. A tip of the introduction piping 11 is positioned near a bottom surface inside the aerosol generator 7 and disposed as being buried in the material particles 5, so that the aerosol 6 is generated when the material particles 5 are blown up by the carrier gas supplied from the gas bomb 10. The generated aerosol 6 is supplied to the spraying nozzle 12 by passing through the introduction piping 11.

A substrate 13 is attached to a substrate holder 14.

As the carrier gas, an inert gas such as helium, argon, and krypton, nitrogen, air, oxygen, and the like may be used, for example, and it is desirable to add oxygen to the carrier gas. By adding oxygen, it is possible to prevent oxygen deficiency that is caused by reduction of the optically transparent metal oxide film and to prevent degradation of charge transport capability.

Hereinafter, this description will be continued by using FIGS. 1 in combination.

The organic film serving as the charge generation layer 2 or a drum on which amorphous silicon is formed is attached to the support 1 that is described in Embodiment 1 to obtain the substrate 13, and the charge transport layer 3 is formed by spraying the aerosol 6 on the substrate 13 by the spray nozzle 12.

It is possible to add various mechanisms to the substrate holder 14 depending on the substrate shape and the substrate size. For example, a mechanism for rotating the substrate holder 14 may be used in the case of forming a cylindrical substrate 13 such as the photoreceptor 50, and a mechanism for controlling in cross direction and horizontal direction (XY axis) is used in the case of requiring a flat and large area. Also, by aligning a multiple of the spray nozzles 12, it is possible to handle a large film formation area, and the mechanisms may be used in combination.

The aerosol deposition method is a method of forming a desired film by spraying and colliding the aerosol obtained by dispersing a superfine particle material into a gas toward the substrate 13 at a high speed and is disclosed in JP-A-2001-181859, for example. In the film obtained by the method, a new surface is formed at a part thereof by generating fine flake particles by fracturing the superfine particles by collision or by deforming the superfine particles by impact caused by collision of the superfine particles, and then the fine flake particles are adhered to the substrate 13 or the fine flake particles are bonded to each other to form a film having high density and excellent in compactness on the substrate 13 without baking. The method is particularly suitable for forming a film from ceramics such as an oxide. A film formation rate of the method is high beyond comparison with plasma CVD and sputtering that are conventional film formation methods.

We have found that it is possible to obtain the photoreceptor 50 having excellent properties with good productivity by using the aerosol deposition method for forming the charge transport layer 3 to be used for the photoreceptor 50.

That is, a so-called amorphous silicon photoreceptor does not achieve good characteristics when plasma CVD is not used, but productivity is remarkably poor when amorphous silicon of several tens of nanometers is formed by plasma CVD, resulting in an increase in cost. Accordingly, with the use of the aerosol deposition method, it is possible to largely improve the productivity. However, with the aerosol deposition method, it is difficult to accurately control a doping concentration, and it is impossible to form the amorphous silicon film satisfactorily functioning as the charge generation layer 2. Therefore, as a material to be used in place of amorphous silicon, we have noted the metal oxide which is photoelectric and optically transparent. However, since spectral sensitivity of the material is in the short wavelength range, and the material does not sensitized with the red laser that is practically used in general electro-photographic apparatuses.

Therefore, by forming the organic film or the amorphous silicon film on the support 1 as the charge generation layer 2 by the method described in Embodiment 1, for example, and forming the optically transparent metal oxide (zinc oxide, for example) on the charge generation layer 2 as the charge transport layer 3 by the above-described aerosol deposition method, it is ultimately possible to realize the photoreceptor 50 that solves all of the conventional problems and has good productivity and characteristics. Since it is unnecessary to increase the film thickness in the case of using the amorphous silicon film as the charge generation layer 2, the use of plasma CVD for film formation does not cause a grave problem from the view point of productivity.

### Embodiment 4

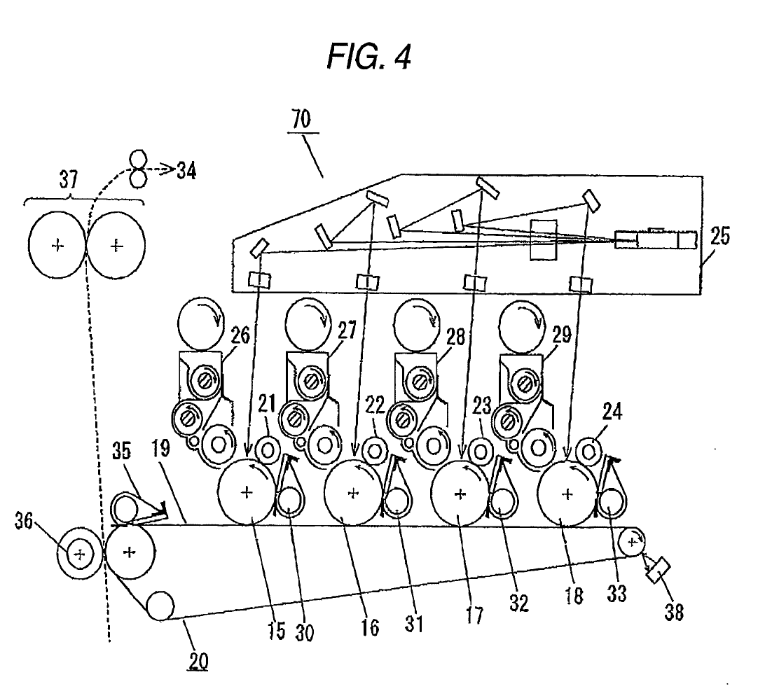

FIG. 4 is a schematic block diagram showing an electro-photographic apparatus 70 according to Embodiment 4 of this invention.

The electro-photographic apparatus 70 shown in FIG. 4 is provided with the photoreceptors 15, 16, 17, and 18 described in detail in Embodiments 1 and 2, an intermediate transfer unit 20 having a belt-like transfer body 19 extending over the photoreceptors, and the like.

Around the photoreceptors 15, 16, 17, and 18, charging devices (charging rollers in this embodiment) 21, 22, 23, and 24, an exposure device 25, developers 26, 27, 28, and 29 each having a developing agent storing unit above itself, photoreceptor cleaners 30, 31, 32, and 33 are disposed. The intermediate transfer unit 20 is provided with a belt cleaner 35 for cleaning a so-called residual toner remaining on a surface of the belt-like transfer body 19 as being not transferred onto a recording sheet 34. A finishing roller 36 required for transferring the transferred and superimposed toner image onto the recording sheet 34 after the toner image is formed by the photoreceptors 15, 16, 17, and 18 is abutted or opposed to the belt-like transfer body 19 of the intermediate transfer unit 20. A fixing unit 37 is a means for fixing the toner image transferred onto the recording sheet 34.

Hereinafter, details of image formation will be described. The photoreceptor 15 according to this invention is exposed by a post-exposure device 25 uniformly charged by the charging device 21, and an electrostatic latent image formed by the exposure is developed by the developer 26. The toner image of which the electrostatic latent image is visualized is transferred onto the belt-like transfer body 19 at a position opposed to or contacting the belt-like transfer body 19 of the intermediate transfer unit 20. In accordance with a timing when the first toner image reaches to the position contacting with the photoreceptor 16, a toner image of a different color formed on a surface of the photoreceptor 16 is transferred onto the first toner image as being overlapped with the first toner image as a second toner image. A third toner image and a fourth toner image are transferred as being overlapped in the same manner to form an overlapped image of four colors. The overlapped image formed on the belt-like transfer body 19 of the intermediate transfer unit 20 is transferred onto the recording sheet 34 at once at a part contacting with the finishing transfer roller 36 and then fixed onto the recording sheet 34 by the fixing unit 37 to form a color image on the recording sheet 34.

The toners that have not been transferred onto the belt-like transfer body 19 from the photoreceptors 15, 16, 17, and 18 in the series of image formation processings are wiped off by the photoreceptor cleaners 30, 31, 32, and 33, but, since the photoreceptor cleaners 30, 31, 32, and 33 are generally formed of a blade or the like, the photoreceptor cleaners 30, 31, 32, and 33 removes the toners that have not been transferred by contacting (sliding on) the photoreceptors 15,16,17, and 18.

Since the photoreceptors 15, 16, 17, and 18 according to this invention have high abrasion resistance (durability), they are suitably used for the cases of setting a processing speed of the electro-photographic apparatus 70 to a higher speed as well as for appliances used in the field where a high throughput is required, such as in so-called heavy duty appliances.

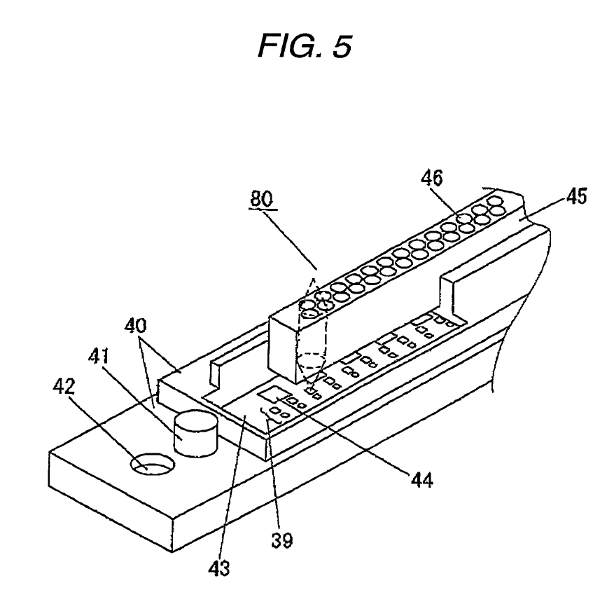

FIG. 5 is a perspective view showing another example of exposure device applied to the electro-photographic apparatus 70 according to Embodiment 4 of this invention.

The exposure device 80 shown in FIG. 5 is obtained by using organic electroluminescence elements that are formed into an array (organic EL element array 39) as an exposure light source.

The organic EL element array 39 is retained in a long housing 40. Positioning pins 41 disposed at opposed ends of the long housing 40 are inserted into positioning holes opposed to the long housing 40 and fixed as being inserted into screw insertion holes 42 provided at opposed ends of the long housing 40 to fix the organic EL element array 39 to a predetermined position as an exposure means corresponding to the photoreceptors 15, 16, 17, and 18.

Each of the organic EL elements forming the organic EL element array 39 is driven by a TFT (Thin Film Transistor) 44 formed on a glass substrate 43 on which the EL element array 39 is formed. A gradient index rod lens array 45 is an imaging optics provided at a front surface of the organic EL light emission element array 39 and is formed by piling gradient index rod lenses 46.

The housing 40 covers a periphery of the glass substrate 43, and one side thereof facing to the photoreceptor (not shown) is opened. With such constitution, a light beam is emitted from the gradient index rod lenses 46 to the photoreceptor for exposure. On a surface of the housing 40 opposed to an end face of the glass substrate 43, a light absorption member (coating) is provided.

Though the exposure device 25 using the laser light source and the exposure device 80 using the organic EL element array are described as examples of the exposure light source in Embodiment 4, a so-called LED head using an LED as the exposure light source may be used as the exposure device.

As a result of operating the electro-photographic apparatus 70 having the above-described structure with the photoreceptor according to this invention being mounted thereof, image quality of the obtained image is comparable to those created by using the conventional organic photoreceptor and amorphous silicon photoreceptor, and, owing to the inorganic material on the outermost surface, improved durability as compared to the organic photoreceptor is confirmed.

In Embodiments 5 to 8 described below, the photoreceptors are obtained by using the aerosol deposition method in the same manner as in the electro-photographic photoreceptor, the production method, the electro-photographic apparatus described in Embodiments 1 to 4, but an object thereof is different from that of Embodiments 1 to 4. The object is to provide an electro-photographic photoreceptor that is highly sensitive to a light source of a short wavelength as well as to provide an electrophotographic photoreceptor production method capable of production in a shorter time and with a simple process. Another object thereof is to provide an electro-photographic apparatus capable of obtaining high resolution image quality by using the electro-photographic photoreceptor.

The electro-photographic photoreceptor of this invention is provided with a support of which at least a surface layer is electro-conductive and a charge generation layer formed from a metal oxide containing nitrogen and provided on the support.

According to this invention, by adding nitrogen to the metal oxide having wide band gap and spectral sensitivity only in the short wavelength range such as 380 nm, the spectral absorption characteristic in the short wavelength range is improved, and it is possible to obtain an electro-photographic photoreceptor having satisfactorily high sensitivity to output light of a blue semiconductor laser (having peak wavelength of 400 nm or more) that has been mass-produced.

Also, since it is possible to use an exposure light source of a shorter wavelength as compared to the conventional red semiconductor laser in the electro-photographic apparatus using the electro-photographic photoreceptor, it is possible to achieve high resolution image quality.

Further, by using the aerosol deposition method capable of achieving the incomparably high film formation rate as compared to the conventional film formation methods such as sputtering and ion plating, it is possible to form the charge generation layer for the electro-photographic photoreceptor without performing complicated film formation processing, easily, and in a short time. Since the aerosol deposition method is suitable for ceramics such as a metal oxide and capable of fully eliciting the excellent properties of metal oxide, the electro-photographic photoreceptor using the method for the charge generation layer exhibits excellent properties.

### Embodiment 5

Hereinafter, this invention will be described in detailed.

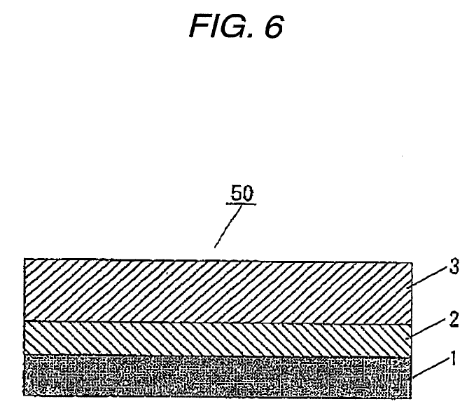

FIG. 6 is a diagram showing a layer structure of a stacked electro-photographic photoreceptor (hereinafter simply referred to as photoreceptor) 50 according to Embodiment 5 of this invention. The photoreceptor 50 is ordinarily in the form of a drum or a belt, and shown in FIG. 6 is an enlarged view of a section of a main part thereof.

Referring to FIG. 6, an electro-conductive support is denoted by 1, a charge generation layer is denoted by 2, and a charge transport layer is denoted by 3, and the charge generation layer 2 of Embodiment 1 is formed from a metal oxide containing nitrogen. In order that the support 1 itself has electro-conductivity, aluminum may typically be used for the support 1. Other than the aluminum, an aluminum alloy, copper, a stainless steel, chromium, titanium, nickel, magnesium, indium, gold, platinum, silver, iron, and the like may be used for the support 1. In addition to the above, those having electro-conductivity and obtained by forming a film of aluminum, indium oxide, tin oxide, gold, or the like by vapor deposition on a dielectric substrate such as plastic, those obtained by mixing plastic or a paper with electroconductive fine particles, and the like may be used. The electroconductive support 1 is required to have uniform electro-conductivity, and a smooth surface property is important. Since the smoothness of a surface of the support 1 greatly influences on uniformity of the charge generation layer 2 and the charge transport layer 3 that are formed thereon, a surface roughness thereof may preferably be 0.5 μm or less.

The drum-shaped photoreceptor 50 is ordinarily formed by using a metal material having electro-conductivity and the like for the support 1 itself and the belt-like photoreceptor 50 is ordinarily formed by using a resin material such PET for the support 1 and forming a metal film on the support 1. For the brevity of description, the metal film in the latter photoreceptor is omitted in FIG. 1, but the metal film is included in the support 1.

Though the structure wherein the charge generation layer 2 is directly formed on the support 1 is shown in FIG. 6, an underlayer having an injection prevention function and an adhesion function may be provided between the support 1 and the charge generation layer 2 (not shown). The underlayer is used for electrically setting a resistance between the support 1 and the charge generation layer 2 within a predetermined range and is indispensable when the charge generation layer 2 is formed of amorphous silicon. Typical Examples of materials for the underlayer include casein, polyvinylalcohol, nitrocellulose, an ethylene-acrylic acid copolymer, polyvinylbutyral, a phenol resin, polyamide, polyurethane, gelatin, and the like.

For the charge transport layer 3, a material having capability of transporting electrons or a material having capability of transporting holes is used as required. Examples of the hole transport material include low molecular organic compounds such as pyrene-based, carbazole-based, hydrazone-based, oxazole-based, oxadiazole-based, pyrazoline-based, arylamine-based, arylmethane-based, benzidine-based, thiazole-based, stilbene-based, and butadiene-based materials, high molecular organic compounds such as poly-N-vinylcarbazole, halogenated poly-N-vinylcarbazole, polyvinylpyrene, polyvinylanthracene, polyvinylacridine, a pyrene-formaldehyde resin, an ethylcarbazole-formaldehyde resin, a triphenylmethane polymer, and polysilane, and the like.

Examples of the electron transport material include organic compounds such as benzoquinone-based, tetracyanoethylene-based, tetracyanoquinodimethane-based, fluorenone-based, xanthone-based, phenanthraquinone-based, phthalic anhydride-based, and diphenoquinone-based materials and inorganic materials such as amorphous silicon, zinc oxide, titanium oxide, and tin oxide.

Though it is possible to use organic and inorganic materials for the charge transport layer 3 as described above from the view points of characteristics, it is preferable to use the inorganic material that is excellent in mechanical strength as compared to an organic film from the view point of reliability as described above.

The metal oxide containing nitrogen is used for the charge generation layer 2 in Embodiment 5. Except for unorthodox metal oxides such as lead oxide (PbO) and cadmium oxide (CdO), metal oxide materials in general are stable in the atmosphere and abundant as a resource, pollution free, and excellent in semiconductor characteristics. Therefore, there are many advantages of using the metal oxide as the main material for the optical functional film, and the advantages of using the metal oxides such as zinc oxide (ZnO) or titanium oxide (TiO₂) for the charge generation layer 2 of the photoreceptor 50 is remarkably great since the metal oxides are semiconductor materials having the photoelectric effect required as the charge generation material for photoreceptors.

Since the conventional metal oxides such as zinc oxide and titanium oxide indicated above have wide band gaps of 3.3 eV and 3.2 eV and do not exhibit the photoelectric effect of generating charges by absorbing light energy with a wavelength of the conventional red semiconductor laser and a blue semiconductor laser that has recently been put into practical use, it has been impossible to use the metal oxides for the charge generation layer 2 of the photoreceptor 50. However, as a result of various studies on elongation of the spectral absorption band of the metal oxides conducted by the inventors of this invention, it has been found that the addition of nitrogen is considerably effective.

It has been known that it is possible to achieve an elongated wavelength of zinc oxide to a certain degree by adding Li, Pd, Cd, Cu, or the like to zinc oxide (see JP-A-2000-321803, for example), it is difficult to precisely control the added element with high reproducibility with the method. The reason for the difficulty is that a composition of a target base material and that of a film to be formed are not always identical with each other in sputtering and plasma injection using plasma to cause a difference therebetween. Also, the fine particles are required for forming a film with the aerosol deposition method, and various limitations are put on the formation of fine particles when the element such as Li, Pd, Cd, and Cu is added. The method of adding nitrogen, which was found by us, does not raise such problems and enables to contain a predetermined amount of nitrogen easily and accurately by adding nitrogen to an introduced gas used when forming a film.

Though the structure of providing the charge generation layer 2 and the charge transport layer 3 in this order on the support 1 is described in the foregoing description, the structure of providing the charge transport layer 3 and the charge generation layer 2 in this order on the support 1 does not cause any problem and enables good characteristics as the photoreceptor 50.

A method of forming a protection layer having high rigidity on an outermost surface of the photoreceptor 50 has heretofore been known, and this method may of course be applied to the structure of Embodiment 5. One preferred example thereof is a case of using carbon or a thin film formed by using carbon as the protection film, and a case of using a diamond-like carbon film (DLC film) as the protection layer is particularly preferred. The DLC film is an amorphous structural body in which a diamond bonding and a graphite bonding are mixed and manufactured by using a vacuum film formation method such as plasma CVD, optical CVD, sputtering, and the like and supplying a hydrocarbon gas such as methane, ethane, propane, butadiene and a hydrogen, fluorine (NF₃), nitrogen (N₂), or boron (BF₃) gas, and the like. In the case of forming the DLC film as the protection film (not shown) on the charge transport layer 3, it is necessary to consider damages to be caused on the metal oxide film used as the charge transport layer 3 as well as to set optimal conditions considering film formation conditions such as a film formation rate, substrate heating, and a bias voltage and a gas to be used. A required film thickness of the protection film is not particularly specified, but a film thickness of 1 μm or less is generally preferred since sensitivity as the photoreceptor 50 is degraded when the thickness is too high, resulting in failure to obtain good image quality.

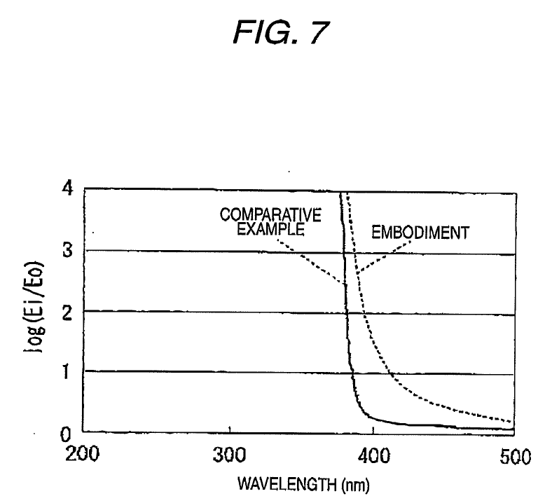

FIG. 7 is a diagram showing characteristics indicating results of measurement of spectral absorption characteristics of zinc oxide in Embodiment 5 of this invention. Also, spectral absorption characteristics of a zinc oxide film not containing nitrogen are also shown in FIG. 7 for comparison.

Hereinafter, a zinc oxide film containing nitrogen which forms the charge generation layer 2 serving as a main element of the photoreceptor 50 in Embodiment 5 will be described in detail.

In Embodiment 5, the zinc oxide forming the charge generation layer 2 of the photoreceptor 50 is formed by sputtering under the following film formation conditions. A graphite glass is used as a sample for the measurement for the purpose of avoiding absorption of a short wavelength, and the zinc oxide film was formed on the graphite glass under the following conditions.
Target: zinc oxide having purity of 99.99%
Introduced gas: mixture gas of argon and nitrogen (nitrogen concentration: 10%)
High frequency power density: 2.5 [W/cm²]
Substrate heating: room temperature
Film thickness: 1 [μm]

The zinc oxide film not containing nitrogen, which is used as Comparative Example, is formed under the same conditions except for using a 100%-argon gas as the introduced gas. In the following description, the zinc oxide film containing nitrogen is referred to as Embodiment, while the zinc oxide film not containing nitrogen is referred to as Comparative Example.

As is apparent from FIG. 7, the zinc oxide film of Embodiment formed under a mixture gas atmosphere of argon which is an inert gas and nitrogen in increased in absorption in the long wavelength region as compared to Comparative Example formed under the inert gas atmosphere. The horizontal axis in the drawing represents a wavelength of incident light, while the vertical axis represents logarithm, so that incident light energy E₁ and transmitted light energy E₀ are represented by log (E₁/E₀). For example, at the wavelength of 400 nm, the light energy is absorbed at a high efficiency of 90% or more in this Embodiment. In turn, it is apparent that the zinc oxide film of Comparative Example formed under the inert gas atmosphere has scarce sensitivity to the wavelength.

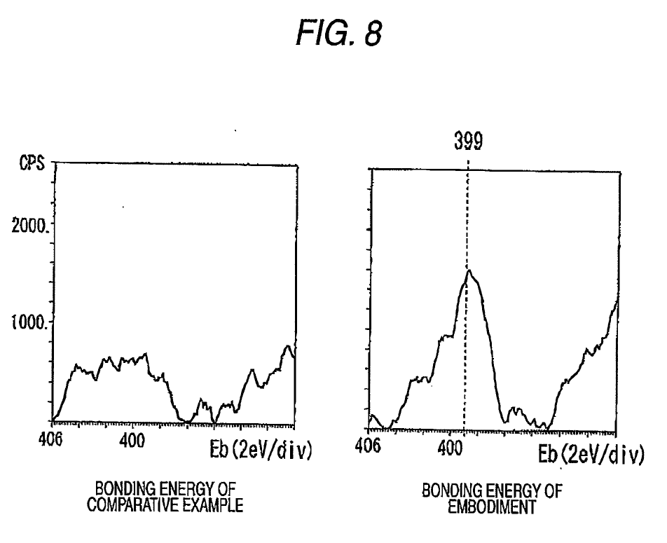

FIG. 8 is a diagram showing characteristics indicating results of measurement of a state of electron energy by an X-ray electron spectroscopy in Embodiment 5 of this invention.

With the method, it is possible to measure an amount of nitrogen contained in the zinc oxide film. A sample used for the measurement was the same as that used in Embodiment and Comparative Example shown in FIG. 7. As is apparent from FIG. 8, the zinc oxide film of Embodiment formed under the inert gas+nitrogen atmosphere has the peak near 399 eV which is the bonding energy indicating presence of nitrogen, while the peak near the bonding energy is not observed in the zinc oxide film of Comparative Example formed under the inert gas atmosphere. That is, the zinc oxide film formed under the inert gas+nitrogen atmosphere contains nitrogen. The precise mechanism of shifting of the spectral absorption band by nitrogen contained in zinc oxide has not been clarified yet, but it is assumed that the effect of nitrogen inclusion in the film contributes to the elongated wavelength of the spectral absorption characteristics shown in FIG. 7.

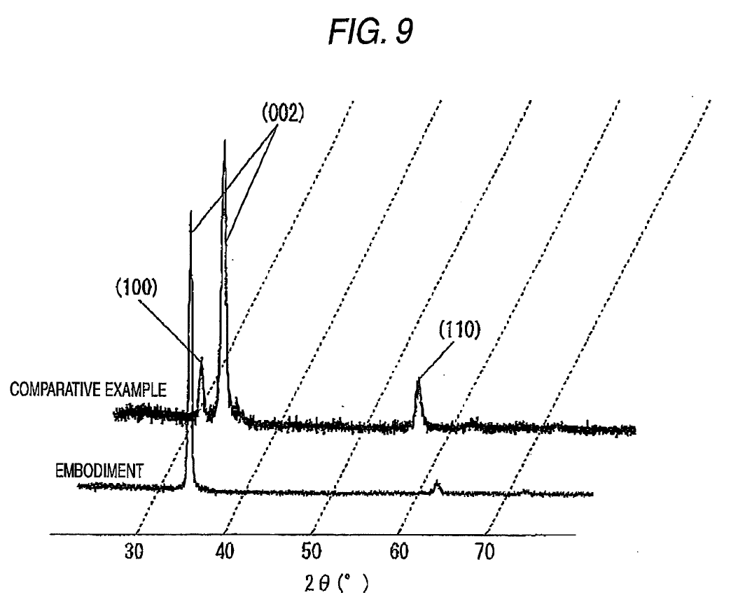

FIG. 9 is a diagram showing characteristics indicating results of observation of crystal structures by x-ray diffraction of a zinc oxide film containing nitrogen and a zinc oxide film not containing nitrogen.

The zinc oxide film of Embodiment and the zinc oxide film of Comparative Example are apparently different in crystal structure. The zinc oxide film of Comparative Example has the (002) aspect dominantly oriented, while the (100) aspect and the (110) aspect in Embodiment are oriented in addition to (002) aspect. The difference in orientation is considered to be one of factors for manifestation of the difference in spectral absorption characteristics of the films.

As disclosed in Patent Publication 4, the crystal structure of zinc oxide influences on characteristics of a photoreceptor such as sensitivity and a charging property. Naturally, the change in crystal structure caused by containing nitrogen largely influences on the characteristics such as specific resistivity and carrier mobility that decide characteristics of the photoreceptor.

As described in the foregoing, since the zinc oxide film containing nitrogen has the spectral absorption band shifted to the long wavelength range and influences on the charging property and the carrier mobility, it is possible to obtain the photoreceptor 50 achieving excellent properties that have not been achieved in the art by optimizing the film formation conditions such as a nitrogen concentration under a film formation atmosphere.

The characteristics of the nitrogen-containing zinc oxide film have been described by taking the example of film formation by sputtering, and it has been confirmed that the same effects are achieved by a zinc oxide film formed by the aerosol deposition method, which will be described later in this specification, and that it is possible to cause the film to contain nitrogen by adding nitrogen to an introduced gas.

Further, it has been confirmed that metal oxides other than zinc oxide, particularly titanium oxide, achieve effects of nitrogen inclusion similar to those of zinc oxide containing nitrogen, and an elongated wavelength of spectral absorption of a titanium oxide film has been realized by causing the titanium oxide film to contain nitrogen. Therefore, it is possible to use the titanium oxide film containing nitrogen for a charge generation layer of a photoreceptor.

### Embodiment 6

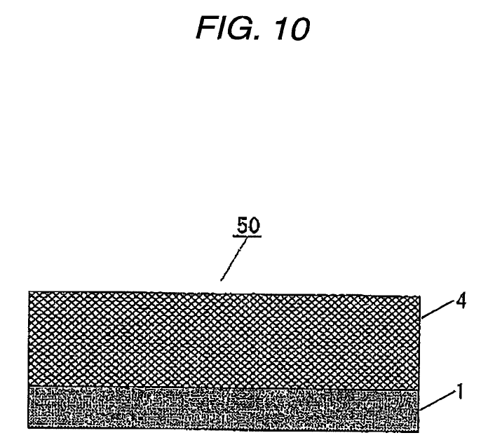

FIG. 10 is a diagram showing a layer structure of an electrophotographic photoreceptor 50 according to Embodiment 6 of this invention.

The photoreceptor 50 according to this invention is not limited to the stacked photoreceptor 50 described in Embodiment 5, and it has been confirmed that the same effects are achieved by a single layer type photoreceptor 50.

In the single layer type photoreceptor 50, it is necessary to impart both of characteristics of the charge generation capability and the charge transport capability. A photosensitive layer 4 in Embodiment 6 achieves both of the characteristics of charge generation capability and charge transport capability as a result of mixing a metal oxide film containing nitrogen and a metal oxide film not containing nitrogen by simultaneously forming the films.

For simultaneously forming the above-described two types of metal oxide films, a nitrogen concentration of an introduced gas (mixture gas of inert gas and nitrogen) to be introduced into a film formation apparatus is relatively reduced, for example. By relatively reducing the nitrogen concentration, the film formed as the photosensitive layer 4 is in a state where the metal oxide containing nitrogen and the metal oxide not containing nitrogen is mixed.

Zinc oxide and titanium oxide may suitably be used as the metal oxide in Embodiment 6, too.

Hereinafter, the metal oxide containing nitrogen will be described.

In zinc oxide, for example, a crystal structure of a hexagonal system (wurtzite form) is formed by combination of basic structures in each of which zinc atoms and oxygen atoms are tetrahedrally coordinated by other four atoms. It is assumed that, when nitrogen is included in the structure, a structure wherein a part of the four atoms bonding to one another is substituted by a nitrogen atom or a structure wherein nitrogen enters the hexagonal crystal structure is formed.

By increasing the nitrogen concentration or by achieving an active state, it is possible to promote nitrogen at the level of the above-described crystal structure, but physical properties of zinc oxide are naturally changed by nitriding. The promotion of nitriding is preferable from the view point of spectral absorption, but the physical properties required as the photoreceptor 50 such as photoelectric characteristics and abrasion resistance are not always obtained by the nitriding promotion. Therefore, by controlling the state of nitriding through the control on the nitrogen concentration as described above, it is possible to obtain properties appropriate for the photoreceptor 50 by creating a film in which an oxide and an oxide containing nitrogen are mixed.

The above-described two types of metal oxide films may be formed alternately. In this case, a plurality of bombs charged with introduced gases are connected to a film formation chamber, and the introduced gases are switched as required. For example, by continuously supplying an argon gas as the introduced gas and supplying a nitrogen gas at a certain interval and for a certain period of time, oxide containing nitrogen is obtained only during the period in which nitrogen is supplied. Since this method enables to successively obtain a stacked structural body of an oxide and an oxide containing nitrogen as well as to control the interval, the period, and a flow rate for introducing nitrogen, it is possible to control characteristics of the film, thereby achieving the characteristics appropriate for the photoreceptor 50.

The method for obtaining the single layer type photoreceptor 50 is not limited to the above-described film-formation by mixing. Since a content of nitrogen influences on physical properties of the metal oxide such as an absorption wavelength, mobility, and a specific resistivity, the characteristics as the photoreceptor 50 are achieved only by the metal oxide containing nitrogen and without mixing the metal oxide containing nitrogen and the metal oxide not containing nitrogen when optimization is conducted while taking the nitrogen content and the characteristics of metal oxide into consideration.

As described in Embodiment 5, it has been confirmed that the same effects are achieved in the case of using carbon or the thin film formed by using carbon as a main ingredient.

### Embodiment 7

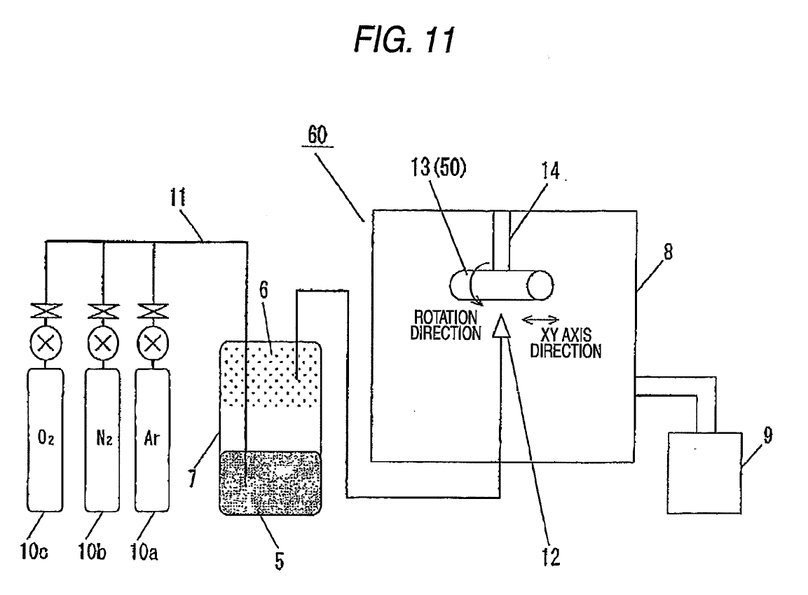

FIG. 11 is a schematic diagram showing a film formation apparatus 60 employing an aerosol deposition method according to Embodiment 7 of this invention.

Hereinafter, with reference to FIG. 11, a description will be given on a method for producing the photoreceptor 60 by using the aerosol deposition method which is suitable as a method for forming metal oxide.

The film formation apparatus 60 used in Embodiment 7 is provided with an aerosol generator 7 for forming an aerosol 6 by dispersing material particles 5 into an introduced gas, a film formation chamber 8 for depositing the aerosol 6 on a substrate by spraying the aerosol 6 from a nozzle, and the like, wherein an evacuation pump 9 is connected to the film formation chamber 8.

Gas bombs 10a, 10b, and 10c for introducing the introduced gases are connected to the aerosol generator 7 via an introduction piping 11, by selecting among the gas bombs 10a, 10b, and 10c for supplying introduced gases, it is possible to supply different introduced gases to the aerosol generator 7 as well as to supply the introduced gases to be supplied from the gas bombs 10a, 10b, and 10c after mixing the introduced gases by independently controlling supply amounts of the introduced gases. For example, the gas bomb 10a is filled with an argon gas which is an inert gas, the gas bomb 10b is filled with nitrogen, and the gas bomb 10c is filled with oxygen.

A tip of the introduction piping 11 is positioned near a bottom surface inside the aerosol generator 7 as being buried into the material particles 5, so that the aerosol 6 is generated when the material particles 5 are blown up by the introduced gases supplied from the gas bombs 10a, 10b, and 10c. The generation aerosol 6 is supplied to the injection nozzle 12 by passing though the introduction piping 11.

The substrate 13 is attached to a substrate holder 14. The substrate 13 serves as the support 1 of the photoreceptor 50 described in Embodiment 1.

An inert gas such as helium, argon, and krypton is ordinarily used as the introduced gas in the aerosol deposition method, but, in Embodiment 7, nitrogen and oxygen are added to the inert gas as required by selecting among the gas bombs 10a, 10b, and 10c or adjusting the supply amounts.

It is possible to cause the metal oxide film to contain nitrogen by adding the nitrogen gas to the inert gas. That is, with the production method described in Embodiment 7, the charge generation layer 2 is formed by forming a film of a metal oxide under an atmosphere in which nitrogen is present.

Also, the reason for further adding the oxygen gas is to avoid oxygen deficiency, i.e. to avoid reduction, during the film formation as well as to prevent deterioration in characteristics of the film due to oxygen shortage in view of the fact that the object of the film formation is the metal oxide.

Hereinafter, this description will be continued by using FIGS. 6 and 10 in combination.

According to the structure of FIG. 11, combinations of the inert gas and the nitrogen gas, the inert gas and the oxygen gas, the inert gas, the nitrogen gas, and the oxygen gas, and the nitrogen gas and the oxygen gas are considered as the gases to be supplied to the film formation chamber 8, and it is possible to obtain the charge generation layer 2 having characteristics appropriate for the photoreceptor 50 by optimizing composition ratios of the gases.

Also, by performing a suitable heat treatment after forming the charge generation layer, the charge transport layer (see FIG. 6), or the photosensitive layer 4 (see FIG. 10) of the photoreceptor 50 by the aerosol deposition method, it is possible to obtain a more stable photoreceptor 50. Presence of inner stress in a film is observed not only in the films formed by the aerosol deposition method, but also in those obtained by sputtering and plasma CVD, and the inner stress causes characteristics deterioration and instability. Since the heat treatment improves the inner stress, improvements in characteristics by the stress alleviation and enhancement in adhesion due to moderate dispersion are expected by the heat treatment.

It is possible to add various mechanisms to the substrate holder 14 depending on the substrate shape and the substrate size. For example, a mechanism for rotating the substrate holder 14 may be used in the case of forming the charge generation layer 2, the charge transport layer 3, or the photosensitive layer 4 on a cylindrical substrate 13 such as the photoreceptor 50. A mechanism for moving the substrate holder 14 in the cross direction and the horizontal direction (XY axis) is used in the case where the substrate 13 requires a flat and large area as in the case of forming the belt-like photoreceptor 50. Further, the rotation mechanism and the XY axis moving mechanism may be combined. Also, by aligning a multiple of the spray nozzles 12, it is possible to handle a large film formation area, and the mechanisms may be used in combination.

The aerosol deposition method is a method for forming a desired film on a surface of the substrate 13 by spraying the aerosol 6 obtained by dispersing a superfine particle material into the gas at a high speed and causing collision of the aerosol 6, and one example thereof is disclosed in JP-A-2001-181859. In the film obtained by the method, a new surface is formed at a part thereof by generating fine flake particles by fracturing the superfine particles by collision or by deforming the superfine particles by impact caused by collision of the superfine particles, and then the fine flake particles are adhered to the substrate 13 or the fine flake particles are bonded to each other to form a film having high density and excellent in compactness on the substrate 13 without baking. The method is particularly suitable for forming a film from ceramics such as an oxide. A film formation rate of the method is high beyond comparison with plasma CVD and sputtering that are conventional film formation methods. We have found that it is possible to obtain the photoreceptor 50 having excellent properties with good productivity by using the aerosol deposition method for forming the charge generation layer 2 to be used for the photoreceptor 50.

There have been two major problems in realizing practical application of the use of the metal oxide film of zinc oxide or the like for the charge generation layer 2 of the photoreceptor 50.

One of them is the difficulty in achieving high sensitivity since a wavelength of a light source for exposure is the long wavelength in the conventional semiconductor infrared laser.

The other is a lack of method for forming a film by a simple processing and in a short time while maintaining the excellent characteristics.

The former problem is being solved by practical application of short wavelength semiconductor laser and future achievement of shorter wavelength as well as shifting of the peak of spectral absorption, i.e. the peak of the sensitivity, in a blue region to the long wavelength range by the inclusion of nitrogen as described in Embodiment 5.

It is possible to solve the latter problem by using the aerosol deposition method of this invention for forming a film of a metal oxide to be used as the charge generation layer 2.

That is, for metal oxides capable of achieving satisfactory photosensitivity with the use of the currently mass-produced short wavelength semiconductor lasers having a wavelength of about 405 nm, the latter problem is solved by using the aerosol deposition method described in detail in Embodiment 3. For metal oxides that achieve satisfactory photosensitivity only with the use of a wavelength of less than 405 nm, it is possible to cause such metal oxides to achieve satisfactory sensitivity with the use of the light source having the wavelength of about 405 nm by shifting a spectral absorption band to a long wavelength by causing the charge generation layer 2 to contain nitrogen. When an ultraviolet laser or the like is put into practical use by the future achievement of shorter wavelength of the semiconductor laser, it is possible to efficiently form the metal oxide to be used as the charge generation layer 2 by employing the aerosol deposition method described in Embodiment 7.

Unlike sputtering and plasma CVD, the aerosol deposition method does not require high vacuum, and such feature contributes to characteristic advantages of not requiring any complicated processing and not requiring equipment investment. In the case where both of the charge generation layer 2 and the charge transport layer 3 of the stacked photoreceptor 50 are formed by inorganic materials, it is preferable to use an identical material for forming the charge generation layer 2 and the charge transport layer 3 in order to maximize the advantages of the aerosol deposition method. That is, a film formed by stopping the nitrogen gas after forming the charge generation layer 2 by mixing nitrogen which is effective for realizing a longer wavelength with the introduced gas, the film serves as the charge transport layer 3, thereby making it possible to form the photoreceptor 50 by the continuous processing as well as to achieve a remarkably efficient production method.

In the aerosol deposition method, it is possible to mix zinc oxide and zinc oxide containing nitrogen by controlling the nitrogen concentration in the introduced gas as described in Embodiment 6, and it is possible to form zinc oxide and zinc oxide containing nitrogen by alternately stacking zinc oxide and zinc oxide containing nitrogen by switching between the introduced gases. More specifically, the introduced gas for the aerosol deposition method is switched between a first introduced gas at least containing nitrogen (the introduced gases are supplied from the gas bomb 10a filled with the inert gas and the gas bomb 10b filled with nitrogen) and a second introduced gas (the introduced gases are supplied from the gas bomb 10c) at least containing oxygen to stack metal oxides of an identical base material (zinc oxide and titanium oxide, for example). Combinations of the introduced gases, gas concentrations, and film thickness of each of the stacked layers are varied depending on characteristics of the material and desired characteristics, and optimization thereof may be conducted as required.

### Embodiment 8

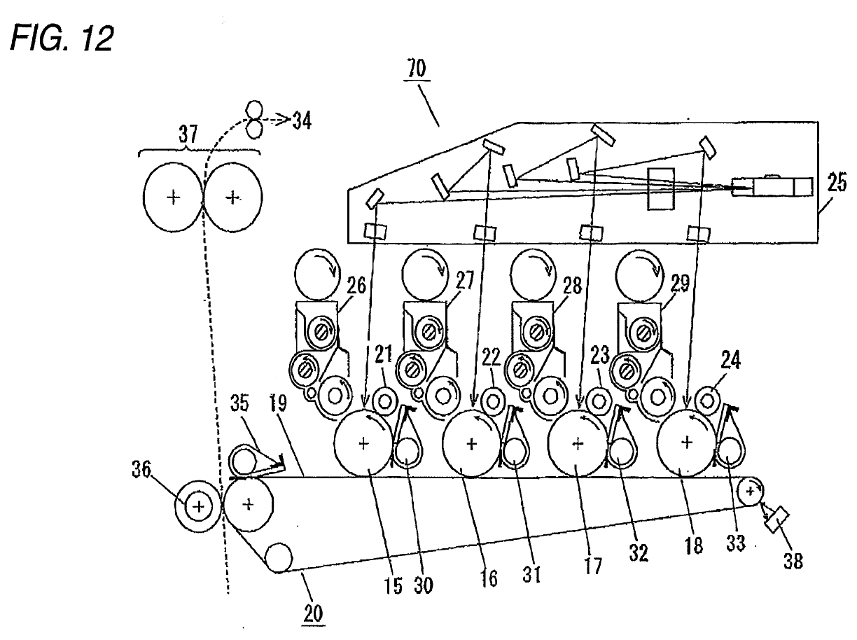

FIG. 12 is a schematic block diagram showing an electrophotographic apparatus 70 according to Embodiment 8 of this invention.

The electro-photographic apparatus 70 shown in FIG. 12 is provided with the photoreceptors 15, 16, 17, and 18 described in detail in Embodiments 5 and 6, an intermediate transfer unit 20 having a belt-like transfer body 19 extending over the photoreceptors, and the like. Around the photoreceptors 15, 16, 17, and 18, charging devices (charging rollers in this embodiment) 21, 22, 23, and 24, an exposure device 25, developers 26, 27, 28, and 29 each having a developing agent storing unit above itself, photoreceptor cleaners 30, 31, 32, and 33 are disposed. The intermediate transfer unit 20 is provided with a belt cleaner 35 for cleaning a so-called residual toner remaining on a surface of the belt-like transfer body 19 as being not transferred onto a recording sheet 34. A finishing roller 36 required for transferring the transferred and superimposed toner image onto the recording sheet 34 after the toner image is formed by the photoreceptors 15, 16, 17, and 18 is abutted or opposed to the belt-like transfer body 19 of the intermediate transfer unit 20. A fixing unit 37 is a means for fixing the toner image transferred onto the recording sheet 34.

Hereinafter, details of image formation will be described. The photoreceptor 15 according to this invention is uniformly charged by the charging device 21 and then exposed by a post-exposure device 25, and an electrostatic latent image formed by the exposure is developed by the developer 26. A semiconductor laser (not shown) having a wavelength of 400 to 415 nm is mounted on the exposure device 25.

The toner image of which the electrostatic latent image is visualized is transferred onto the belt-like transfer body 19 at a position opposed to or contacting the belt-like transfer body 19 of the intermediate transfer unit 20. In accordance with a timing when the first toner image reaches to the position contacting with the photoreceptor 16, a toner image of a different color formed on a surface of the photoreceptor 16 is transferred onto the first toner image as being overlapped with the first toner image as a second toner image. A third toner image and a fourth toner image are transferred as being overlapped in the same manner to form an overlapped image of four colors. The overlapped image formed on the belt-like transfer body 19 of the intermediate transfer unit 20 is transferred onto the recording sheet 34 at once at a part contacting with the finishing transfer roller 36 and then fixed onto the recording sheet 34 by the fixing unit 37 to form a color image on the recording sheet 34.

The toners that have not been transferred onto the belt-like transfer body 19 from the photoreceptors 15, 16, 17, and 18 in the series of image formation processing are wiped off by the photoreceptor cleaners 30, 31, 32, and 33, but, since the photoreceptor cleaners 30, 31, 32, and 33 are generally formed of a blade or the like, the photoreceptor cleaners 30, 31, 32, and 33 removes the toners that have not been transferred by contacting (sliding on) the photoreceptors 15, 16, 17, and 18.

Since the photoreceptors 15, 16, 17, and 18 described in detail in Embodiment 5 and the like have high abrasion resistance (durability), they are suitably used for the cases of setting a processing speed of the electro-photographic apparatus 70 to a higher speed as well as for appliances used in the field where a high throughput is required, such as in so-called heavy duty appliances.

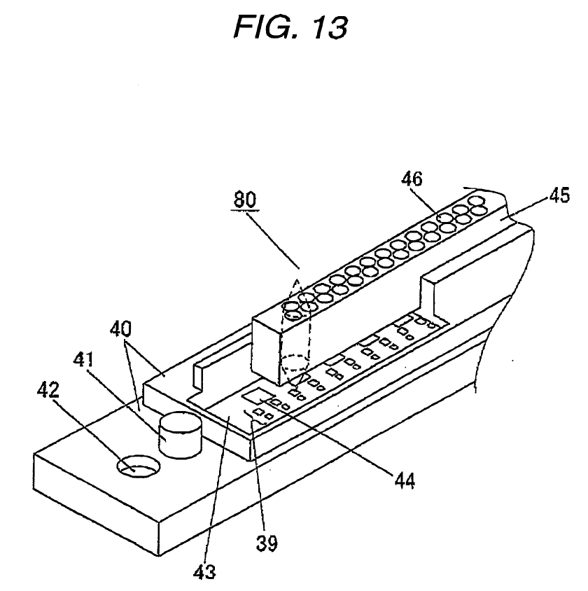

FIG. 13 is a perspective view showing another example of exposure device applied to the electro-photographic apparatus 70 according to Embodiment 8 of this invention.

The exposure device 80 shown in FIG. 13 is obtained by using organic electroluminescence elements that are formed into an array (organic EL element array 39) as an exposure light source. For an emission wavelength of the organic EL element array 39, it is possible to select organic materials for red to blue, and the element emission wavelength may be selected depending on characteristics of the photoreceptors 15, 16, 17, and 18.

The organic EL element array 39 is retained in a long housing 40. Positioning pins 41 disposed at opposed ends of the long housing 40 are inserted into positioning holes opposed to the long housing 40 and fixed as being inserted into screw insertion holes 42 provided at opposed ends of the long housing 40 to fix the organic EL element array 39 to a predetermined position as an exposure means corresponding to the photoreceptors 15, 16, 17, and 18.

Each of the organic EL elements forming the organic EL element array 39 is driven by a TFT (Thin Film Transistor) 44 formed on a glass substrate 43 on which the EL element array 39 is formed. A gradient index rod lens array 45 is an imaging optics provided at a front surface of the organic EL light emission element array 39 and is formed by piling gradient index rod lenses 46.

The housing 40 covers a periphery of the glass substrate 43, and one side thereof facing to the photoreceptor (not shown) is opened. With such constitution, a light beam is emitted from the gradient index rod lenses 46 to the photoreceptor for exposure. On a surface of the housing 40 opposed to an end face of the glass substrate 43, a light absorption member (coating) is provided.

Though the exposure device 25 using the laser light source and the exposure device 80 using the organic EL element array are described as examples of the exposure light source in Embodiment 8, a so-called LED head using an LED as the exposure light source may be used as the exposure device.

As a result of operating the electro-photographic apparatus 70 having the above-described structure and the photoreceptor according to this invention mounted thereon, it was confirmed that resolution of the obtained image is higher than those created by using the conventional organic photoreceptor and amorphous silicon photoreceptor, and, owing to the inorganic material on the outermost surface, improved durability as compared to the organic photoreceptor is confirmed.

The electro-photographic photoreceptor of this invention is provided with the support of which at least the surface has electro-conductivity and the metal oxide containing nitrogen that is provided on the support as the charge generation layer. With such constitution, since it is possible to shift the spectral absorption of the metal oxide (having the sensitivity peak in wavelength region of about 380 nm, for example) serving as the charge generation layer to the long wavelength range (405 nm, for example), it is possible to obtain the electro-photographic photoreceptor having high sensitivity to the existing blue semiconductor lasers.

Also, in this invention, the main ingredient of the metal oxide serving as the charge generation layer is zinc oxide or titanium oxide. By causing the metal oxide such as zinc oxide and titanium oxide having excellent photoelectric effect to contain nitrogen, it is possible to realize the high sensitivity.

Also, the electro-photographic photoreceptor of this invention has the structure that enables satisfactory spectral absorption for the blue wavelength exposure light source. With such structure, it is possible to achieve high sensitivity for the blue short wavelength light sources.

In this invention, the protection film of which the main ingredient is carbon is formed on the outermost surface of the electro-photographic photoreceptor. Since the carbon-based protection film which is excellent in abrasion resistance is disposed on the outermost surface, the effect of improving durability is achieved.

In the electro-photographic photoreceptor production method of this invention, the metal oxide serving as the charge generation layer to be formed on the support of which at least the surface layer has electro-conductivity is formed under the nitrogen atmosphere. With the method, it is possible to easily cause the film of metal oxide to contain nitrogen.

In the electro-photographic photoreceptor production method of this invention, the metal oxide serving as the charge generation layer to be formed on the support of which at least the surface layer has electro-conductivity is formed by the aerosol deposition method. With the method, it is possible to achieve high productivity by the simple processing with the excellent characteristics of the charge generation layer being maintained.

In this invention, oxygen is contained in the introduced gas to be used for the aerosol deposition method. With such constitution, the effect of preventing oxygen deficiency due to reduction of metal oxide and preventing a reduction in charge generation capability is achieved.

In this invention, nitrogen is contained in the introduced gas to be used for the aerosol deposition method. With such constitution, the effect of easily causing the film of metal oxide to contain nitrogen is achieved.

In this invention, oxygen and nitrogen are contained in the introduced gas to be used for the aerosol deposition method. With such constitution, the effect of easily achieving both of the prevention of oxygen deficiency due to reduction of metal oxide and the nitrogen inclusion of the film is achieved.

In this invention, the introduced gas used in the aerosol deposition method is switched between the first gas at least containing nitrogen and the second gas at least containing oxygen to stack metal oxides for which an identical base material is used. Since it is possible to obtain the films different in performance by switching between the introduced gases even when the identical material is used, it is possible to produce the stacked electro-photographic photoreceptor only by switching between the introduced gases in one chamber, thereby achieving high productivity.

In this invention, the heat treatment is performed after forming the charge generation layer and the charge transport layer. Since it is possible to cause stress alleviation and dispersion at layer boundaries, the effect of improving adhesion power between the layers (mechanical strength) is achieved.

The electro-photographic apparatus of this invention has the electro-photographic photoreceptor described above. Since it is possible to use a short wavelength light source as the exposure light source for the electro-photographic apparatus using the electro-photographic photoreceptor according to this invention, the electro-photographic apparatus achieves high resolution image quality.

This application is based upon and claims the benefit of priority of Japanese Patent Application No 2006-333006 filed on Dec. 11, 2006, and Japanese Patent Application No 2007-014775 filed on Jan. 25, 2007, the contents of which is incorporated herein by references in its entirety.

What is claimed is:

1. An electro-photographic photoreceptor comprising:
a support of which at least a surface has electro-conductivity,
a charge transport layer formed from a metal oxide having optical transparency, and
a charge generation layer formed between the support and the charge transport layer.

2. The electro-photographic photoreceptor according to claim 1, wherein the charge generation layer is formed from an organic photoconductive material.

3. The electro-photographic photoreceptor according to claim 1, wherein the charge generation layer is formed from amorphous silicon.

4. The electro-photographic photoreceptor according to claim 1, wherein the charge transport layer is formed mainly from zinc oxide, titanium oxide, or tin oxide.

5. The electro-photographic photoreceptor according to claim 2, wherein the charge transport layer is formed mainly from zinc oxide, titanium oxide, or tin oxide.

6. The electro-photographic photoreceptor according to claim 3, wherein the charge transport layer is formed mainly from zinc oxide, titanium oxide, or tin oxide.

7. The electro-photographic photoreceptor according to claim 1, wherein a protection film mainly consisting of carbon is formed on a surface of the charge transport layer.

8. The electro-photographic photoreceptor according to claim 2, wherein a protection film mainly consisting of carbon is formed on a surface of the charge transport layer.

9. The electro-photographic photoreceptor according to claim 3, wherein a protection film mainly consisting of carbon is formed on a surface of the charge transport layer.

10. The electro-photographic photoreceptor according to claim 1, wherein a buffer layer is further provided between the charge generation layer and the charge transport layer.

11. The electro-photographic photoreceptor according to claim 2, wherein a buffer layer is further provided between the charge generation layer and the charge transport layer.

12. The electro-photographic photoreceptor according to claim 3, wherein a buffer layer is further provided between the charge generation layer and the charge transport layer.

13. An electro-photographic photoreceptor production method, comprising:
forming a charge generation layer on a support of which at least a surface layer has electro-conductivity, and
forming a charge transport layer by an aerosol deposition method.

14. The electro-photographic photoreceptor production method according to claim 13, wherein oxygen is included in an introduced gas used for the aerosol deposition method.

15. The electro-photographic photoreceptor production method according to claim 13, further comprising
a heat treatment which is performed after forming the charge transport layer.

16. An electro-photographic photoreceptor production method, comprising:
forming a charge generation layer on a support of which at least a surface layer has electro-conductivity,
forming a buffer layer by a vacuum vapor deposition method, and
forming a charge transport layer by an aerosol deposition method.

17. The electro-photographic photoreceptor production method according to claim 16, wherein
oxygen is included in an introduced gas used for the aerosol deposition method.

18. The electro-photographic photoreceptor production method according to claim 16, further comprising
a heat treatment which is performed after forming the charge transport layer.

19. An electro-photographic apparatus comprising an electro-photographic photoreceptor, wherein
the electro-photographic photoreceptor comprises a support of which at least a surface has electro-conductivity, a charge transport layer formed from a metal oxide having optical transparency, and a charge generation layer formed between the support and the charge transport layer.

20. The electro-photographic apparatus according to claim 19, wherein
the charge generation layer is formed from an organic photoconductive material.

21. The electro-photographic apparatus according to claim 19, wherein
the charge generation layer is formed from amorphous silicon.

22. The electrophotographic apparatus according to claim 19, wherein
the charge transport layer is formed mainly from zinc oxide, titanium oxide, or tin oxide.

23. The electro-photographic apparatus according to claim 19, wherein
a protection film mainly consisting of carbon is formed on a surface of the charge transport layer.

24. The electro-photographic apparatus according to claim 19, wherein
a buffer layer is further provided between the charge generation layer and the charge transport layer.
